(19) United States
(12) Patent Application Publication
(10) Pub. No.: US 2022/0400162 A1
(43) Pub. Date: Dec. 15, 2022

(54) SYSTEMS AND METHODS FOR MACHINE LEARNING SERVING

(71) Applicant: Meta Platforms, Inc., Menlo Park, CA (US)

(72) Inventors: Luhui Hu, Bellevue, WA (US); Ming Zhao, Palo Alto, CA (US); Daniel Nota Peek, San Mateo, CA (US)

(21) Appl. No.: 17/836,842

(22) Filed: Jun. 9, 2022

Related U.S. Application Data
(60) Provisional application No. 63/210,283, filed on Jun. 14, 2021.

(51) Int. Cl. H04L 67/00; H04L 67/306; G06N 20/20

(52) U.S. Cl. CPC H04L 67/34; H04L 67/306; G06N 20/20

(57) ABSTRACT

Systems, methods, and non-transitory computer-readable media can be configured to provide machine learning data to an edge computing device based on information associated with the edge computing device. A change to the information associated with the edge computing device is determined. One or more machine learning operations can be managed on the edge computing device based at least in part on the change to the information associated with the edge computing device.

### CROSS-REFERENCE TO RELATED APPLICATIONS

This application claims priority to U.S. Provisional Patent Application No. 63/210,283, filed on Jun. 14, 2021 and entitled “SYSTEMS AND METHODS FOR MACHINE LEARNING SERVING,” which is incorporated herein by reference in its entirety.

### FIELD OF THE INVENTION

The present technology relates to the field of federated machine learning. More particularly, the present technology relates to approaches for serving machine learning data in a distributed computing environment.

### BACKGROUND

Federated machine learning techniques typically involve a centralized server that interacts with edge devices. Such federated machine learning techniques enable a distributed machine learning lifecycle that typically involves data collection, feature engineering, modeling, training, evaluating, and serving. For instance, a centralized server can train machine learning models that can be deployed on edge devices.

### SUMMARY

Various embodiments of the present technology can include systems, methods, and non-transitory computer readable media configured to provide machine learning data to an edge computing device based on information associated with the edge computing device. A change to the information associated with the edge computing device is determined. One or more machine learning operations can be managed on the edge computing device based at least in part on the change to the information associated with the edge computing device.

In an embodiment, the machine learning data includes at least one machine learning model and one or more features associated with the at least one machine learning model.

In an embodiment, the change to the information corresponds to at least one of a change to a user preference associated with the edge computing device, a change to a user profile associated with the edge computing device, or a change to a geographic location associated with the edge computing device.

In an embodiment, managing the one or more machine learning operations on the edge computing device includes determining that the machine learning data is outdated; and providing instructions to the edge computing device to disable machine learning operations based on the outdated machine learning data.

In an embodiment, managing the one or more machine learning operations on the edge computing device includes providing instructions to the edge computing device to throttle machine learning operations performed by the edge computing device based on the machine learning data.

In an embodiment, managing the one or more machine learning operations on the edge computing device includes providing an update for the machine learning data to the edge computing device based on the determined change to the information associated with the edge computing device; and providing instructions to the edge computing device to perform machine learning operations based on the update to the machine learning data.

In an embodiment, the update to the machine learning data includes at least one of an update to one or more machine learning models deployed on the edge computing device or an update to a set of features associated with the one or more machine learning models.

In an embodiment, the systems, methods, and non-transitory computer readable media are configured to perform determining that the edge computing device is associated with a given user account; determining a second edge computing device that is also associated with the given user account; and synchronizing machine learning serving between the edge computing device and the second edge computing device based at least in part on provision of the update for the machine learning data to the second edge computing device.

In an embodiment, the systems, methods, and non-transitory computer readable media are configured to perform accessing one or more signals from the edge computing device, wherein the one or more signals are accessible based on one or more policies that enforce restrictions on data access.

In an embodiment, the one or more signals correspond to at least one of user interactions with content accessed through the edge computing device or user browsing metrics associated with content accessed through the edge computing device.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1A illustrates a conventional federated machine learning system.

FIG. 1B illustrates an example federated machine learning system for serving machine learning data in a distributed computing environment, according to an embodiment of the present technology.

FIG. 2 illustrates an example federated cloud module, according to an embodiment of the present technology.

FIG. 3 illustrates an example federated edge module, according to an embodiment of the present technology.

FIG. 4 illustrates an example diagram of a distributed computing environment, according to an embodiment of the present technology.

FIG. 5 illustrates an example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

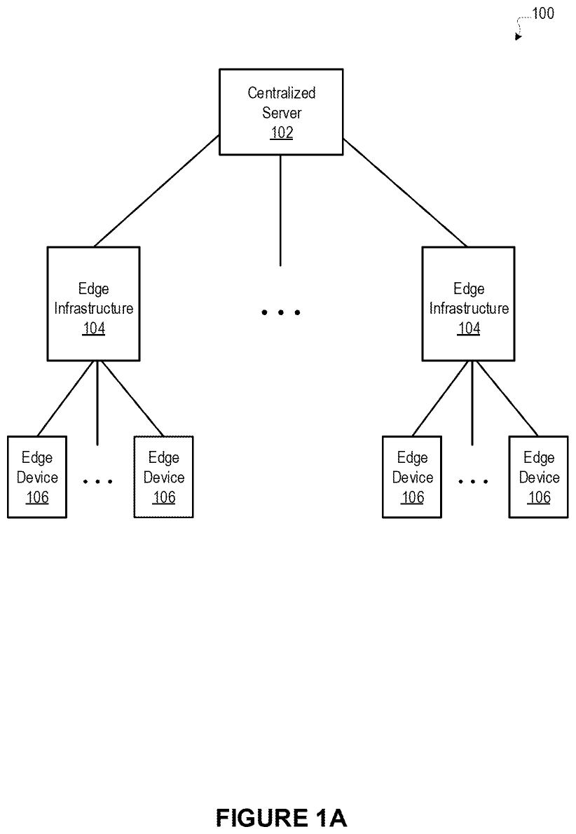

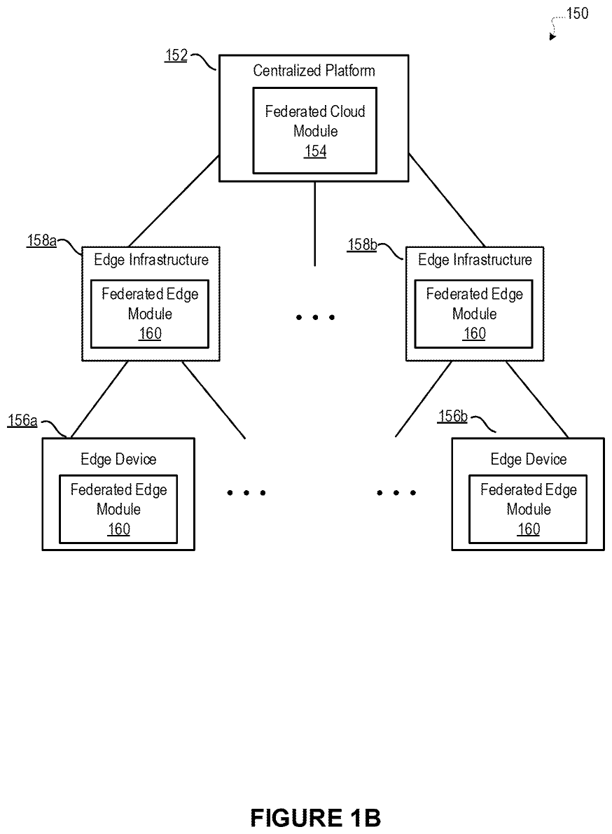

Federated machine learning techniques typically involve a centralized server that interacts with edge devices. Such federated machine learning techniques enable a distributed machine learning lifecycle that typically involves data collection, feature engineering, modeling, training, evaluating, and serving. For instance, a centralized server can train machine learning models that can be deployed on edge devices. The machine learning models can be trained based on global datasets managed by the centralized server and local datasets that are stored on the edge devices. In some implementations, the edge devices can upload local datasets to the centralized server. Based on local datasets as well as global datasets, the centralized server can train machine learning models that can be deployed on the edge devices. FIG. 1A illustrates a conventional federated machine learning system 100. The federated machine learning system 100 includes a centralized server 102, edge infrastructure 104, and edge devices 106. The centralized server 102 can comprise one or more computing systems. The edge infrastructure 104 can include a plurality of distributed data centers that provide a resource-dense midpoint between the centralized server 102 and the edge devices 106. The edge devices 106 can be computing devices with real-time data processing capabilities, for example, for purposes of training and deploying machine learning models for various end-user applications.

Although the conventional federated machine learning system 100 of FIG. 1A can be used to train and deploy machine learning models, the conventional approach of the federated machine learning system 100 experiences a number of challenges when serving machine learning data to edge devices in a distributed computing environment. One challenge involves synchronization of machine learning data (e.g., machine learning models, model features, etc.) deployed on edge devices. For example, the centralized server 102 can distribute machine learning models to the edge devices 106. Each edge device 106 can individually perform machine learning operations (e.g., serving, inference, etc.) based on the distributed machine learning models. For example, the operations can involve provision of various features to a machine learning model to obtain one or more outputs, such as content rankings, recommendations, translations, and other types of information. In some instances, an edge device may deploy an outdated (or incorrect) version of a machine learning model. For example, the deployed machine learning model may become outdated due to the edge device lacking network access or otherwise being offline. Under conventional approaches, the edge device may continue to rely on the outdated machine learning model to provide outputs (e.g., rankings, recommendations, etc.) that may be incorrect, inconsistent, or otherwise sub-optimal. In some instances, outputs that are incorrect, inconsistent, or otherwise sub-optimal can significantly degrade user experience.

Another challenge involves personalization. In general, each edge device performs its own operations based on machine learning models deployed on the edge device. However, personalization of such operations on edge devices can be challenging because each edge device may require its own personalization mechanism for a particular user or a group of users. The implementation of such personalization mechanisms in each edge device can result in an inefficient allocation and use of computing resources associated with edge devices.

Another challenge involves consistency between machine learning operations (e.g., serving, inference, etc.). In some instances, an inconsistency between machine learning operations can arise when a user is associated with multiple edge devices. For example, a user may be logged into the same user account (e.g., a content provider account, social networking account, etc.) on multiple edge devices (e.g., mobile phone, laptop, etc.). Each edge device may deploy different machine learning models. As a result, the edge devices may perform machine learning operations based on different machine learning models, which can result in an inconsistent user experience. That is, the user may be provided different recommendations, content, or other information on different edge devices even though the different edge devices are logged into the same user account. In some instances, an inconsistency between machine learning operations can arise due to changes in geographic location. That is, a machine learning model deployed on an edge device associated with a user can become outdated when the user is traveling. For example, during traveling, the edge device may remain connected to a previous edge data center (or infrastructure) that has outdated machine learning data instead of connecting to another current edge data center that has more up-to-date machine learning data based on changes to the user location. In another example, the edge device may fail to timely fetch location-specific machine learning models when the user is traveling. As a result, machine learning operations performed by the edge device can provide incorrect, inconsistent, or outdated outputs. As an example, the edge device may deploy outdated machine learning models that provide advertisements relevant to users located in San Francisco even after the user is no longer in San Francisco.

Another challenge involves consistency between features that are served to edge devices. In general, it can be difficult for edge devices to store all of the potential features that can be evaluated by machine learning models. Given that such features may be updated frequently, it can be difficult to ensure that edge devices have access to features that are consistent and up-to-date for the machine learning models that are deployed on the edge devices.

Another challenge involves privacy issues that can arise when collecting and accessing data associated with edge devices. For example, user-generated signals (e.g., reactions, likes, feedback, etc.) on edge devices can be important for incremental learning and incremental training of machine learning models. However, it can be difficult to maintain user privacy when such information is communicated between edge devices or between an edge device and a centralized server. In another example, it can be difficult to enforce privacy policies and requirements that are applicable to certain geographies, especially as users travel from one location to another. In yet another example, it can be difficult to respect user privacy and prevent data leaks when a user is associated with multiple edge devices. In particular, conventional approaches typically do not provide a mechanism to internally link edge devices associated with a user for purposes of securely maintaining and sharing sensitive information between the edge devices. Thus, conventional approaches pose these and other problems arising in computer technology.

An improved approach rooted in computer technology overcomes the foregoing and other disadvantages associated with conventional approaches specifically arising in the realm of computer technology. In various embodiments, the present technology provides a federated machine learning serving solution that can intelligently manage and administer deployment of machine learning data (e.g., machine learning models, model features, etc.). The federated machine learning serving solution can include a centralized platform 152 that interacts with edge devices 156a, 156b via edge infrastructure 158a, 158b, as illustrated in the example of FIG. 1B. The centralized platform 152 can comprise a plurality of computing servers that are logically centralized and physically distributed for reliability and availability. The centralized platform 152 can communicate with the edge devices 156a, 156b and data centers associated with the edge infrastructure 158a, 158b over one or more computer networks (e.g., the internet). Further, in some embodiments, the edge devices 156a, 156b can communicate with one another over one or more computer networks. Further still, in some embodiments, data centers associated with the edge infrastructure 158 can communicate with one another over one or more computer networks.

As shown in the example of FIG. 1B, the centralized platform 152 can implement a federated cloud module 154. The edge devices 156a, 156b can implement a federated edge module 160. In some embodiments, the edge infrastructure 158a, 158b can also implement the federated edge module 160. For example, the edge infrastructure 158a, 158b may comprise a plurality of computing systems that are associated with data centers. In this example, one or more of the plurality of computing systems in one or more data centers can implement the federated edge module 160. Based on operations performed by the federated cloud module 154 and the federated edge modules 160, the centralized platform 152 can intelligently enable federated machine learning serving to the edge devices 156a, 156b and the edge infrastructure 158a, 158b. The federated cloud module 154 and the federated edge modules 160 can enable communications between the centralized platform 152; the edge infrastructure 158a, 158b; and the edge devices 156a, 156b over one or more computer networks. That is, based on operations performed by the federated cloud module 154 and the federated edge modules 160, the centralized platform 152 can provide various information to the edge infrastructure 158a, 158b. The edge infrastructure 158a, 158b can provide this information to the edge devices 156a, 156b. Similarly, the edge devices 156a, 156b can provide various information to the edge infrastructure 158a, 158b. The edge infrastructure 158a, 158b can provide this information to the centralized platform 152. In some instances, the edge devices 156a, 156b can provide the information directly to the centralized platform 152. In various embodiments, the centralized platform 152 can manage federated machine learning data and serve the federated machine learning data to the edge devices 156 to improve personalization and consistency. That is, the centralized platform 152 can serve machine learning data (e.g., machine learning models, model features, etc.) to the edge devices 156 in a manner that improves personalization. For example, the personalization may involve providing content rankings, recommendations, or other information that are customized for a given user (or a group of users). In another example, the personalization may involve customization of the various types of information (e.g., content, advertisements, etc.) that are provided to a user of the edge devices 156. The centralized platform 152 can serve updated machine learning data to the edge devices 156 as needed to help ensure that users of the edge devices 156 enjoy a personalized experience. The centralized platform 152 can also help ensure that the same versions of machine learning models and related model features are served across all edge devices that are associated with a user. As a result, the centralized platform 152 helps ensure that the user has a consistent experience across multiple edge devices associated with the user. For example, the user may be logged into a social networking system from multiple edge devices, including a mobile phone and a laptop. In this example, the centralized platform 152 can ensure that the multiple edge devices deploy up-to-date machine learning data so that the user is provided a consistent experience (e.g., rankings, recommendations, translations, etc.) across the multiple edge devices. The centralized platform 152 can also monitor and forecast changes to the edge devices 156, such as network-related changes (e.g., network traffic, network availability, etc.) and location-related changes (e.g., changes to a geographic location associated with an edge device). The centralized platform 152 can evaluate such forecasted changes and accordingly modify (or adapt) any operations that are performed in connection with federated machine learning serving. Further, the centralized platform 152 can manage and enforce various legal and non-legal restrictions that govern the collection and access of data to help safeguard user data. More details relating to the present technology are provided below.

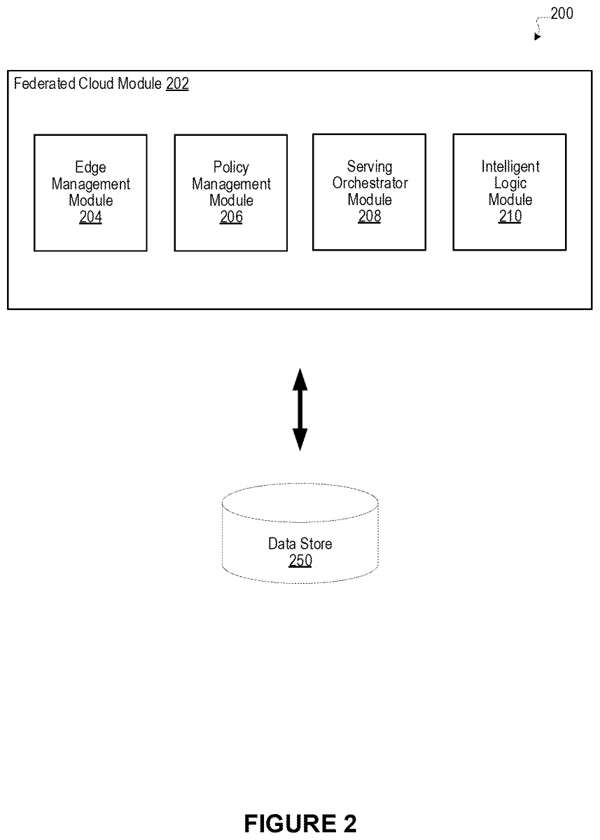

FIG. 2 illustrates an example system 200 including a federated cloud module 202, according to an embodiment of the present technology. In some embodiments, the federated cloud module 202 can implement functionality of the federated cloud module 154. As shown in the example of FIG. 2, the federated cloud module 202 can include an edge management module 204, a policy management module 206, a serving orchestrator module 208, and an intelligent logic module 210. In some instances, the example system 200 can include a data store 250 in communication with the federated cloud module 202. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the edge management module 204, the policy management module 206, the serving orchestrator module 208, and the intelligent logic module 210 can be implemented in any suitable combinations.

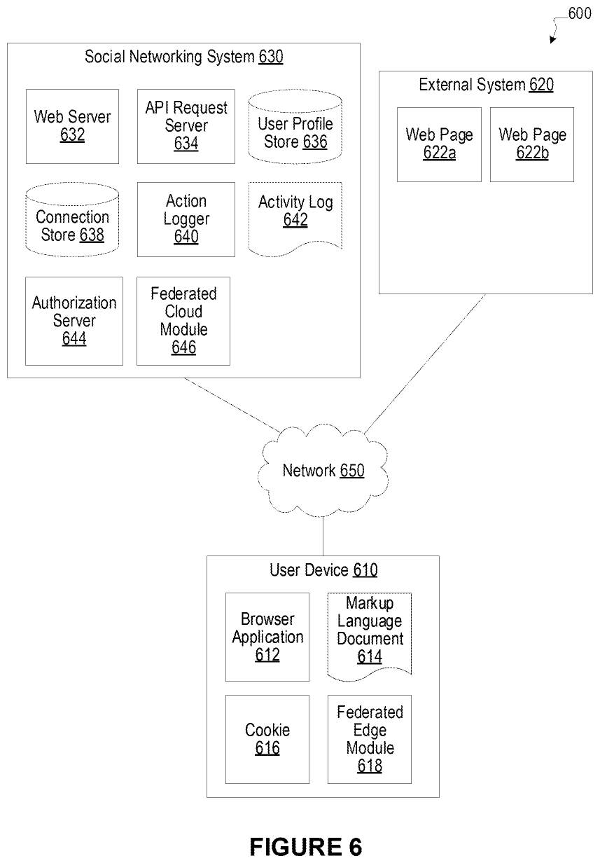

In some embodiments, the federated cloud module 202, the edge management module 204, the policy management module 206, the serving orchestrator module 208, and the intelligent logic module 210 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some instances, the federated cloud module 202, the edge management module 204, the policy management module 206, the serving orchestrator module 208, and the intelligent logic module 210 can be, in part or in whole, implemented as software running on one or more computing devices or systems, such as on a server system or a client computing device. In some instances, the federated cloud module 202, the edge management module 204, the policy management module 206, the serving orchestrator module 208, and the intelligent logic module 210 can be, in part or in whole, implemented within or configured to operate in conjunction with or be integrated with a social networking system (or service), such as a social networking system 630 of FIG. 6. Likewise, in some instances, the federated cloud module 202, the edge management module 204, the policy management module 206, the serving orchestrator module 208, and the intelligent logic module 210 can be, in part or in whole, implemented within or configured to operate in conjunction with or be integrated with a client computing device, such as the user device 610 of FIG. 6. For example, the federated cloud module 202, the edge management module 204, the policy management module 206, the serving orchestrator module 208, and the intelligent logic module 210 can be implemented as or within a dedicated application (e.g., app), a program, or an applet running on a user computing device or client computing system. The application incorporating or implementing instructions for performing functionality of the federated cloud module 202, the edge management module 204, the policy management module 206, the serving orchestrator module 208, and the intelligent logic module 210 can be created by a developer. The application can be provided to or maintained in a repository. In some instances, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The federated cloud module 202, the edge management module 204, the policy management module 206, the serving orchestrator module 208, and the intelligent logic module 210 can be configured to communicate and/or operate with the data store 250, as shown in the example system 200. The data store 250 can be configured to store and maintain various types of data. In some implementations, the data store 250 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 250 can store information that is utilized by the federated cloud module 202, the edge management module 204, the policy management module 206, the serving orchestrator module 208, and the intelligent logic module 210. For example, the data store 250 can store machine learning data, such as various versions and configurations of many different machine learning models that are trained for myriad applications based on various feature sets. The data store 250 can store different versions of feature data, including up-to-date feature sets that can be used as inputs to the machine learning models. In various embodiments, model data and feature data can be grouped (or categorized) for personalization. For example, model data and feature data can be categorized based on a geographic location, an event, or a season. Many variations are possible. Further, the data store 250 can store policies that govern data collection and access. For example, the policies can codify rules for collecting and accessing data based on legal and non-legal privacy frameworks. Further still, the data store 250 can store signal data obtained from edge devices in accordance with the policies that govern data collection and access. The signal data can include user-generated signals, for example, based on user engagement with content items (e.g., likes, reactions, comments, shares, etc.). In some embodiments, the signal data can be used for incremental learning and training of machine learning models. The signal data can also be used for managing global serving of machine learning data and edge infrastructure and device management. It is contemplated that there can be many variations or other possibilities.

The edge management module 204 can be configured to manage edge devices (e.g., mobile phones, smartwatches, laptops, tablets, etc.) in a distributed computing environment. That is, in various embodiments, the edge management module 204 can manage respective profiles associated with edge devices. For example, a profile associated with an edge device can describe various characteristics (or features) of a user that is associated with the edge device. In instances where the user is associated with multiple edge devices, the edge management module 204 can coordinate machine learning operations (e.g., serving, inference, etc.) so that such edge devices deploy identical (or compatible) versions and configurations of machine learning models and feature sets, thereby enabling a consistent experience for the user.

The edge management module 204 can be configured to maintain respective states (e.g., time zones, geographic locations, etc.) associated with edge devices provided that such disclosure is authorized by users associated with the edge devices. By maintaining associations between edge devices and their respective states, the edge management module 204 can detect state changes and, in response, dynamically modify machine learning operations based on such changes. For example, the edge management module 204 can determine when a geographic location associated with an edge device has changed. In this example, the edge management module 204 can serve location-based machine learning models to the edge device so that any outputs (e.g., rankings, recommendations, etc.) provided by the machine learning models are relevant to a current geographic location of a user of the edge device.

The edge management module 204 can also be configured to access (or obtain) signals collected (or generated) through edge devices. For example, the signals may be generated by an edge device and may include metrics related to machine learning models deployed on the edge device. In another example, the signals may be generated based on a user of an edge device. In this example, the signals may correspond to user feedback (e.g., interactions, likes, emoji reactions, comments, shares, etc.) to content accessed through the edge device. In yet another example, the signals may correspond to user browsing metrics, such as times of day when content is accessed, types of content accessed, and watch times (or view durations) associated with accessed content, to provide some examples. Many variations are possible. In various embodiments, the edge management module 204 can access such signals in accordance with policies that are managed and enforced by the policy management module 206. The edge management module 204 can provide signals obtained from edge devices to the data store 250 for storage and management.

The policy management module 206 can be configured to manage and enforce policies that govern data collection and access. For example, a policy may be associated with rules that govern collection of data on edge devices and subsequent access to that data. There can be many different policies that codify such rules. For example, a first policy can govern collection of user data (or signals) from edge devices, a second policy can govern provision of data to edge devices (e.g., feature distribution), and a third policy can govern sharing of data between edge devices. Many variations are possible. The policy management module 206 can determine which policies apply to users or their edge devices, and can provide the applicable policies to those edge devices for enforcement. For example, some policies may apply to edge devices that are associated with a particular geographic region (or jurisdiction). For example, data associated with users residing in the state of California may be subject to a policy that follows the California Consumer Privacy Act (CCPA) while data associated with users residing in the European Union may be subject to a policy that follows the General Data Protection Regulation (GDPR).

The serving orchestrator module 208 can be configured to serve machine learning data (e.g., machine learning models, feature data, etc.) to edge devices. For example, the serving orchestrator module 208 can provide machine learning data to edge devices in a manner that promotes performance, personalization, and consistency. For example, the serving orchestrator module 208 can improve the performance of machine learning serving by managing machine learning operations that are performed on edge devices. For example, the serving orchestrator module 208 can instruct an edge device to disable machine learning operations that are performed based on an outdated machine learning model. In another example, the serving orchestrator module 208 can disable serving of outdated features to an edge device. In yet another example, the serving orchestrator module 208 can instruct edge devices to throttle machine learning operations to reallocate local computing resources for more resource-intensive operations. The serving orchestrator module 208 can also improve the personalization of machine learning serving based on information associated with edge devices. For example, an edge device may be associated with information that identifies user preferences, a user account, a geographic location, or a profile (e.g., user profile, device profile, etc.). In this example, the serving orchestrator module 208 can serve machine learning data to the edge device based on the associated information. The serving orchestrator module 208 can also improve the consistency of machine learning serving by managing machine learning data that is deployed on edge devices. For example, the serving orchestrator module 208 can determine when machine learning data deployed on an edge device is outdated or sub-optimal. In this example, the serving orchestrator module 208 can provide the edge device with corresponding updates to the deployed machine learning data. For example, the serving orchestrator module 208 can provide an updated version of a deployed machine learning model, an updated configuration for a deployed machine learning model, or a new machine learning model that replaces a deployed machine learning model in its entirety. Similarly, the serving orchestrator module 208 can provide updated sets of features that can be used as inputs to machine learning models deployed on an edge device. Many variations are possible.

The intelligent logic module 210 can be configurated to determine and forecast changes to states associated with edge devices. For example, the intelligent logic module 210 can be configurated to determine and forecast changes to geographic locations associated with edge devices. The intelligent logic module 210 can use such forecasts to help improve personalization by providing edge devices with location-specific machine learning data (e.g., machine learning models, features, etc.) in advance. Further, the intelligent logic module 210 can use such forecasts to identify and enforce applicable policies that govern data collection and access. In some embodiments, the intelligent logic module 210 can extract various features and related attributes from the data store 250 to enable incremental learning and training of machine learning models based on generally known approaches. The extracted features and attributes can include signal data obtained from edge devices. The signal data can include user-generated signals, for example, based on user engagement with content items (e.g., likes, reactions, comments, shares, etc.).

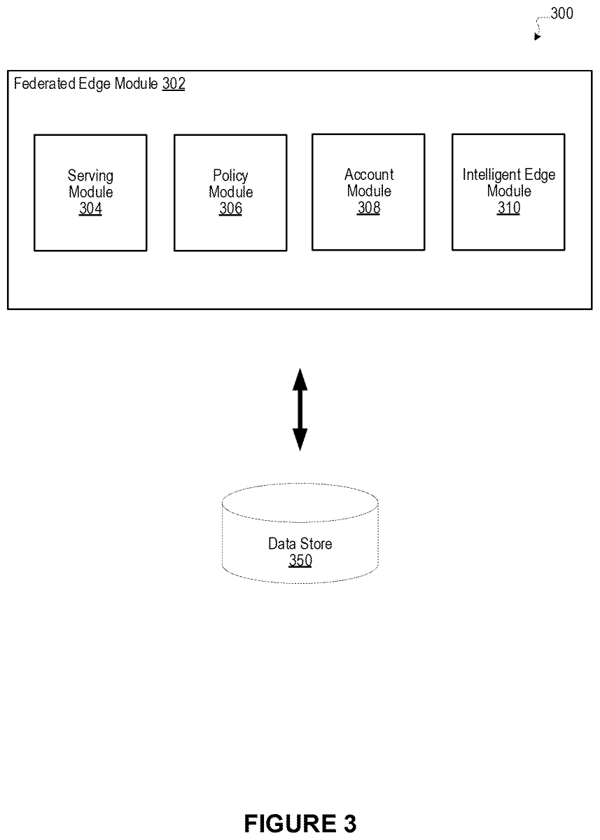

FIG. 3 illustrates an example system 300 including a federated edge module 302, according to an embodiment of the present technology. For example, the federated edge module 302 can be implemented in edge infrastructure (e.g., a data center) or an edge device. In some embodiments, the federated edge module 302 can implement functionality of the federated edge module 160. As shown in the example of FIG. 3, the federated edge module 302 can include a serving module 304, a policy module 306, an account module 308, and an intelligent edge module 310. In some instances, the example system 300 can include a data store 350 in communication with the federated edge module 302. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the serving module 304, the policy module 306, the account module 308, and the intelligent edge module 310 can be implemented in any suitable combinations.

In some embodiments, the federated edge module 302, the serving module 304, the policy module 306, the account module 308, and the intelligent edge module 310 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some instances, the federated edge module 302, the serving module 304, the policy module 306, the account module 308, and the intelligent edge module 310 can be, in part or in whole, implemented as software running on one or more computing devices or systems, such as on a server system or a client computing device. In some instances, the federated edge module 302, the serving module 304, the policy module 306, the account module 308, and the intelligent edge module 310 can be, in part or in whole, implemented within or configured to operate in conjunction with or be integrated with a social networking system (or service), such as a social networking system 630 of FIG. 6. Likewise, in some instances, the federated edge module 302, the serving module 304, the policy module 306, the account module 308, and the intelligent edge module 310 can be, in part or in whole, implemented within or configured to operate in conjunction with or be integrated with a client computing device, such as the user device 610 of FIG. 6. For example, the federated cloud module 302, the serving module 304, the policy module 306, the account module 308, and the intelligent edge module 310 can be implemented as or within a dedicated application (e.g., app), a program, or an applet running on a user computing device or client computing system. The application incorporating or implementing instructions for performing functionality of the federated edge module 302, the serving module 304, the policy module 306, the account module 308, and the intelligent edge module 310 can be created by a developer. The application can be provided to or maintained in a repository. In some instances, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The federated edge module 302, the serving module 304, the policy module 306, the account module 308, and the intelligent edge module 310 can be configured to communicate and/or operate with the data store 350, as shown in the example system 300. The data store 350 can be configured to store and maintain various types of data. In some implementations, the data store 350 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 350 can store information that is utilized by the federated edge module 302, the serving module 304, the policy module 306, the account module 308, and the intelligent edge module 310. For example, the data store 350 can store machine learning data, such as various versions and configurations of many different machine learning models that are trained for various applications based on various feature sets. The data store 350 can store different versions of feature data, including up-to-date feature sets that can be used as inputs to the machine learning models. In various embodiments, model data and feature data can be grouped (or categorized) for personalization. For example, model data and feature data can be categorized based on a geographic location, an event, or a season. Many variations are possible. Further, the data store 350 can store policies that govern data collection and access. For example, the policies can codify rules for collecting and accessing data based on legal and non-legal privacy frameworks. Further still, the data store 350 can store signal data obtained from an edge device in accordance with the policies that govern data collection and access. The signal data can include user-generated signals, for example, based on user engagement with content items (e.g., likes, reactions, comments, shares, etc.). In some embodiments, the signal data can be used for incremental learning and training of machine learning models. It is contemplated that there can be many variations or other possibilities.

The serving module 304 can be configured to manage machine learning operations on edge devices based on interactions with the serving orchestrator module 208 of FIG. 2. For example, the serving module 304 can determine which machine learning operations to perform and not to perform based on information provided by the serving orchestrator module 208. The serving module 304 can similarly determine machine learning data (e.g., machine learning models, model features, etc.) based on which machine learning operations can be performed. Further, the serving module 304 can also manage access to feature sets for deployed machine learning models. In some embodiments, the serving module 304 can collect various signals generated by an edge device including, for example, user feedback signals provided in response to accessed content items as well as user browsing metrics, such as times of day when content is accessed, types of content accessed, and watch times, to provide some examples.

The policy module 306 can be configured to manage and enforce policies that govern data collection and access. For example, the policy module 306 can manage and enforce policies that are applicable to a given edge device based on interactions with the policy management module 206 of FIG. 2. The policy module 306 can enforce such policies to govern data collection on the edge device and access to that data in network communications, for example, between the federated cloud module 202 and the federated edge module 302 or between the federated edge module 302 and a federated edge module implemented in another edge device (or edge infrastructure). Many variations are possible.

The account module 308 can be configured to determine a user account associated with an edge device. The account module 308 can also maintain information identifying different edge devices that are associated with the same user account. For example, the account module 308 can determine that a mobile phone and a tablet device associated with a user are logged into the same user account. In this example, the account module 308 can synchronize states (e.g., time zones, geographic locations, etc.) and user profiles across such edge devices to efficiently and consistently serve machine learning data.

The intelligent edge module 310 can be configured to determine and forecast changes to an edge device. For example, the intelligent edge module 310 can forecast network-related changes (e.g., network traffic, network availability, etc.) and location-related changes (e.g., changes to a geographic location associated with an edge device). The changes may be forecasted based on historical network data, historical location data, and various user signals. Further, in some embodiments, the changes may be forecasted based on one or more machine learning models that are trained to predict such changes. The intelligent edge module 310 can use such forecasts to help improve local management of edge devices and machine learning operations that are performed on the edge devices. For example, the intelligent edge module 310 can fetch location-specific machine learning models when a user is expected to travel to a given geographic region before the user loses network connectivity. The intelligent edge module 310 can also use such forecasts to improve communications between a centralized server, edge infrastructure, and edge devices associated with a federated machine learning system.

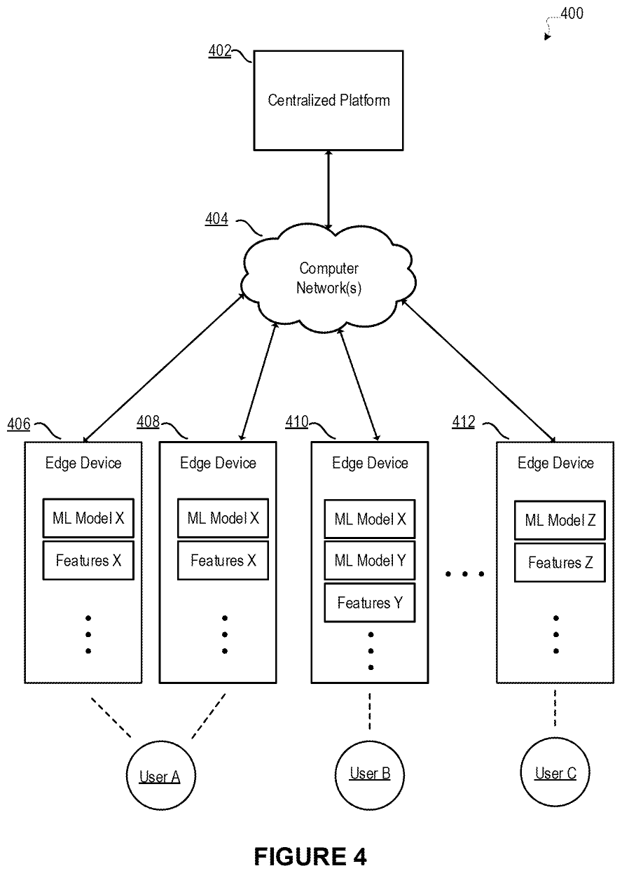

FIG. 4 illustrates an example diagram 400 of a distributed computing environment, according to an embodiment of the present technology. The distributed computing environment includes a centralized platform 402 that is in communication with a plurality of edge devices through one or more computer networks 404. For example, the centralized platform 402 can implement the federated cloud module 202 of FIG. 2. The edge devices can each implement the federated edge module 302 of FIG. 3. In the example of FIG. 4, the centralized platform 402 can determine that an edge device 406 and an edge device 408 are associated with a User A. For example, the centralized platform 402 can determine a relationship between the edge device 406 and the edge device 408 based on both the edge device 406 and the edge device 408 being logged into the same user account. In this example, the centralized platform 402 can provide the same machine learning data (e.g., ML Model X, Features X, etc.) to both the edge device 406 and the edge device 408 to improve personalization and consistency between machine learning operations performed for User A. The centralized platform 402 can also determine that a User B associated with an edge device 410 is expected to travel from one geographic region to another. In this example, the centralized platform 402 can instruct the edge device 410 to cease machine learning operations based on outdated machine learning data (e.g., ML Model X, etc.). The centralized platform 402 can also provide the edge device 410 with more current or relevant machine learning data (e.g., ML Model Y, Features Y, etc.) that can be used to perform machine learning operations at User B's travel destination. Further, the centralized platform 402 can access signals generated through an edge device 412. For example, the signals can reflect user interactions (e.g., reactions, likes, comments, shares, feedback, etc.) with content accessed through the edge device 412. In this example, the centralized platform 402 can obtain and use the signals, for example, to perform incremental learning and incremental training of machine learning models. Many variations are possible.

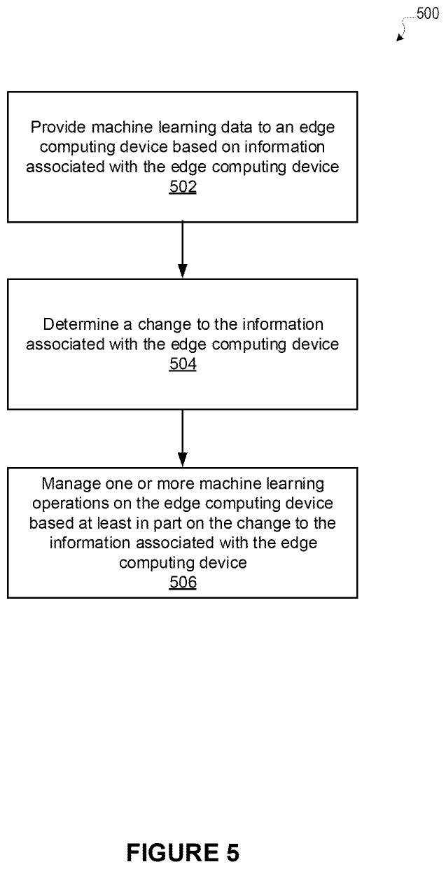

FIG. 5 illustrates an example method 500, according to an embodiment of the present technology. It should be understood that there can be additional, fewer, or alternative steps performed in similar or alternative orders, or in parallel, based on the various features and embodiments discussed herein unless otherwise stated. At block 502, the example method 500 can provide machine learning data to an edge computing device based on information associated with the edge computing device. At block 504, a change to the information associated with the edge computing device is determined. At block 506, one or more machine learning operations can be managed on the edge computing device based at least in part on the change to the information associated with the edge computing device.

It is contemplated that there can be many other uses, applications, and/or variations associated with the various embodiments of the present technology. For example, in some cases, a user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, according to an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a federated cloud module 646. The federated cloud module 646 can be implemented with, for example, the federated cloud module 202, as discussed in more detail herein. In some embodiments, the user device 610 can include a federated edge module 618. The federated edge module 618 can be implemented with, for example, the federated edge module 302, as discussed in more detail herein. It should be appreciated that there can be many variations or other possibilities.

### Hardware Implementation

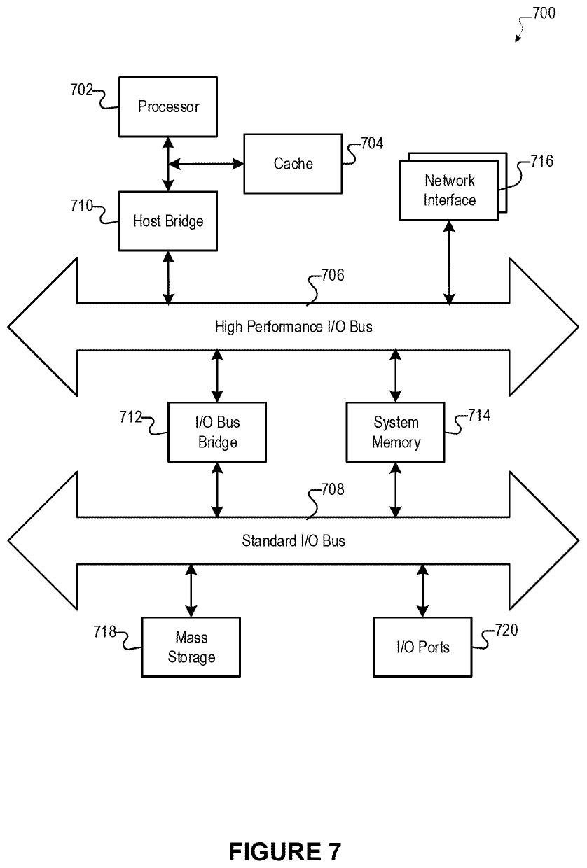

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the present technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
providing, by a computing system, machine learning data to an edge computing device based on information associated with the edge computing device;
determining, by the computing system, a change to the information associated with the edge computing device; and
managing, by the computing system, one or more machine learning operations on the edge computing device based at least in part on the change to the information associated with the edge computing device.

2. The computer-implemented method of claim 1, wherein the machine learning data includes at least one machine learning model and one or more features associated with the at least one machine learning model.

3. The computer-implemented method of claim 1, wherein the change to the information corresponds to at least one of a change to a user preference associated with the edge computing device, a change to a user profile associated with the edge computing device, or a change to a geographic location associated with the edge computing device.

4. The computer-implemented method of claim 1, wherein managing the one or more machine learning operations on the edge computing device further comprises:
determining, by the computing system, that the machine learning data is outdated; and
providing, by the computing system, instructions to the edge computing device to disable machine learning operations based on the outdated machine learning data.

5. The computer-implemented method of claim 1, wherein managing the one or more machine learning operations on the edge computing device further comprises:
providing, by the computing system, instructions to the edge computing device to throttle machine learning operations performed by the edge computing device based on the machine learning data.

6. The computer-implemented method of claim 1, wherein managing the one or more machine learning operations on the edge computing device further comprises:
providing, by the computing system, an update for the machine learning data to the edge computing device based on the determined change to the information associated with the edge computing device; and
providing, by the computing system, instructions to the edge computing device to perform machine learning operations based on the update to the machine learning data.

7. The computer-implemented method of claim 6, wherein the update to the machine learning data includes at least one of an update to one or more machine learning models deployed on the edge computing device or an update to a set of features associated with the one or more machine learning models.

8. The computer-implemented method of claim 6, further comprising:
determining, by the computing system, that the edge computing device is associated with a given user account;
determining, by the computing system, a second edge computing device that is also associated with the given user account; and
synchronizing, by the computing system, machine learning serving between the edge computing device and the second edge computing device based at least in part on provision of the update for the machine learning data to the second edge computing device.

9. The computer-implemented method of claim 1, further comprising:
accessing, by the computing system, one or more signals from the edge computing device, wherein the one or more signals are accessible based on one or more policies that enforce restrictions on data access.

10. The computer-implemented method of claim 9, wherein the one or more signals correspond to at least one of user interactions with content accessed through the edge computing device or user browsing metrics associated with content accessed through the edge computing device.

11. A system comprising:
at least one processor; and
a memory storing instructions that, when executed by the at least one processor, cause the system to perform:
providing machine learning data to an edge computing device based on information associated with the edge computing device;
determining a change to the information associated with the edge computing device; and
managing one or more machine learning operations on the edge computing device based at least in part on the change to the information associated with the edge computing device.

12. The system of claim 11, wherein the machine learning data includes at least one machine learning model and one or more features associated with the at least one machine learning model.

13. The system of claim 11, wherein the change to the information corresponds to at least one of a change to a user preference associated with the edge computing device, a change to a user profile associated with the edge computing device, or a change to a geographic location associated with the edge computing device.

14. The system of claim 11, wherein managing the one or more machine learning operations on the edge computing device further causes the system to perform:
determining that the machine learning data is outdated; and
providing instructions to the edge computing device to disable machine learning operations based on the outdated machine learning data.

15. The system of claim 11, wherein managing the one or more machine learning operations on the edge computing device further causes the system to perform:
providing instructions to the edge computing device to throttle machine learning operations performed by the edge computing device based on the machine learning data.

16. A non-transitory computer-readable storage medium including instructions that, when executed by at least one processor of a computing system, cause the computing system to perform:
providing machine learning data to an edge computing device based on information associated with the edge computing device;
determining a change to the information associated with the edge computing device; and
managing one or more machine learning operations on the edge computing device based at least in part on the change to the information associated with the edge computing device.

17. The non-transitory computer-readable storage medium of claim 16, wherein the machine learning data includes at least one machine learning model and one or more features associated with the at least one machine learning model.

18. The non-transitory computer-readable storage medium of claim 16, wherein the change to the information corresponds to at least one of a change to a user preference associated with the edge computing device, a change to a user profile associated with the edge computing device, or a change to a geographic location associated with the edge computing device.

19. The non-transitory computer-readable storage medium of claim 16, wherein managing the one or more machine learning operations on the edge computing device further causes the computing system to perform:
determining that the machine learning data is outdated; and
providing instructions to the edge computing device to disable machine learning operations based on the outdated machine learning data.

20. The non-transitory computer-readable storage medium of claim 16, wherein managing the one or more machine learning operations on the edge computing device further causes the computing system to perform:
providing instructions to the edge computing device to throttle machine learning operations performed by the edge computing device based on the machine learning data.
